(19) United States
(12) Patent Application Publication
(10) Pub. No.: US 2015/0217476 A1
(43) Pub. Date: Aug. 6, 2015

(54) MATERIAL FORMING APPARATUS

(71) Applicant: Donald S. LUPA, North Aurora, IL (US)

(72) Inventors: Donald S. Lupa, North Aurora, IL (US); Steve B. Torre, Rockford, IL (US)

(21) Appl. No.: 14/429,324

(22) PCT Filed: Sep. 17, 2013
(86) PCT No.: PCT/US2013/060223

§ 371 Date: Mar. 18, 2015

Related U.S. Application Data
(63) Continuation-in-part of application No. 13/621,636, filed on Sep. 17, 2012, now Pat. No. 9,004,900.

(51) Int. Cl. B27H 1/00; B29C 51/26; B29C 53/80; B29C 51/38; B29C 53/04; B29C 51/20; F16H 19/08

(52) U.S. Cl. CPC B27H 1/00; B29C 51/20; B29C 51/26; F16H 19/08; B29C 51/38; B29C 53/04; B29C 53/80; B29L 2031/772

(57) ABSTRACT

The present invention is a material forming apparatus that includes an array of gears including a plurality of drive gears and a plurality of driven gears, each driven gear in engagement with a drive gear to form a gear set, and at least one of the driven gear and corresponding drive gear being non-circular so as to alter the pitch as the drive gear adjusts its respective driven gear, includes a flexible bed having a plurality of bed arms, each bed arm being connected to a corresponding gear set, the flexible bed arms form a generally flat bed and a second position where the plurality of bed arms are positioned in desired positions in order to manipulate the flexible bed into a non-linear configuration at least at some point, and includes at least one clamp to hold a workpiece to the flexible bed so that the workpiece matches the non-linear configuration of the flexible bed when the flexible bed is moved from the first position to the second position.

This application is a continuation-in-part of application Ser. No. 13/621,636, filed Sep. 17, 2012, the entire disclosure of which is incorporated herein by reference.

### TECHNICAL FIELD & BACKGROUND OF THE INVENTION

Traditional material forming apparatuses are limited in that they can often form only one fixed radius fixture at a time to form a material into a specific radius shape.

Thus, a need exists for a material forming apparatus that can be dialed into a plurality of unlimited radii to provide a platform to form one or more various materials into a specific radius shape and be reused to provide a platform to form one or more additional materials into a shape with another specific radius of curvature.

### SUMMARY OF THE INVENTION

An apparatus for forming material into different curved shapes is disclosed herein. In one form, a manual apparatus is disclosed having a flexible bed that receives a workpiece or piece of material and includes clamps for securing the piece of material to the flexible bed. The apparatus further includes one or more cranks for driving a plurality of drive gears and coupled driven gears to move at least a portion of the flexible bed between an initial flat or unformed position and a second position wherein at least a portion of the flexible bed is curved (e.g., formed or bent) to a desired radius of curvature. In one form, the apparatus includes a first crank for moving a first end of the flexible bed and associate clamped piece of material between the initial position and the formed position, and a second crank for moving a second end of the flexible bed and associated clamped piece of material between the initial position and the formed position to curve the workpiece along desired radii of curvature.

It is an object of the invention to provide a material forming apparatus that saves time and money by eliminating a need to build a plurality of fixed radius fixtures or forms that only work for a specific shape.

It is an object of the invention to provide a material forming apparatus that can be used to form wood for curved moldings, panels and other suitable wood products, but is not limited to any other material that uses one or more fixed molding forms through the use of one or more fixtures and clamps.

It is an object of the invention to provide a material forming apparatus that can be used to thermoform plastics and acrylics to a desired radius by providing a forming platform after being heated to a specified temperature.

What is really needed is a material forming apparatus that saves time and money by eliminating a need to build a plurality of fixed radius fixtures or forms that only work for a specific shape, such a material forming apparatus would save time and money by eliminating a need to build a plurality of fixed radius fixtures or forms that only work for a specific shape that can be used to form wood for curved moldings, panels and other suitable wood products, but is not limited to any other material that uses one or more fixed molding forms through the use of one or more fixtures or forms and clamps. Such a material forming apparatus can also preferably be used to thermoform plastics and acrylics to a desired radius by providing a forming platform after being heated to a specified temperature.

In addition to the above and in other forms of the invention, an automated material forming apparatus is disclosed having a flexible bed, one or more clamp members for clamping a workpiece to the bed, a plurality of drive gears and a plurality of driven gears that engage with one another and move respective portions of the flexible bed. The automated material forming apparatus further includes a controller and gear box for moving the plurality of drive and driven gear sets and their associated flexible bed portions into desired positions to form the workpiece as desired. In a preferred form, at least one of the drive gear and/or driven gear is out of round or a non-circular gear in order to have an ever changing pitch as the gears move. With such a configuration the gear sets drive the arms coupled to the driven gears at different: rates causing the flexible bed and associated clamped workpiece to curve as desired. If desired, the automated material forming apparatus may include limit switches (electrical, mechanical and/or electro-mechanical limit switches) which are used to prevent the gears from being moved beyond a desired point. For example, in one form mechanical limit switches are positioned in line with at least one of the gears, shafts, arms or bed arm assemblies in order to make or break contact in order to signal to the controller that a limit of travel has been reached.

In another form, the invention includes drive gears and/or driven gears wherein at least one of the drive gear or driven gear are adjustable to allow for fine adjustment or alignment of the gears and/or their associate arm or bed arm assemblies. In a preferred form, each drive gear is keyed with an adjustable key mechanism that allows for independent alignment of the associated arm or bed arm assembly. Each driven gear also preferably includes an adjustable gear lock assembly that allows the driven gear to be locked to the arm shaft to prevent slippage between the driven gear and the arm shaft. In one form, the driven gear is keyed to the arm shaft or driven shaft and includes a screw for eliminating any backlash between the keyed portions of the driven gear and the arm shaft. Preferably the key will include a plurality of key slots recessed in the arm shaft and driven gear with individual keys inserted into respective key slots defined by the aligned recesses of the arm shaft and driven gear. In a preferred form, the individual arm shafts or driven shafts further includes friction reducing mechanisms, such as bushings, that align the shaft with respective openings in the housing of the material forming apparatus to prevent wear on the arm shaft and reduce friction related to the rotation of the arm shaft. In alternate forms, other friction reducing mechanisms, such as ball bearings, may be used. In a preferred form, the distal end of the arm shaft is tapered and/or keyed to the arm in order to maintain proper alignment of the arm shaft and arm to the driven gear. The arm shaft is also preferably fastened to the arm to ensure movement of the arm shaft translates into a corresponding and repeatable movement of the arm.

The invention may further include a counter balancing system for aligning and maintaining the position of the driven gears with their respective drive gears so that alignment is maintained even when the drive gears are disengaged from their respective driven gears (e.g., such as for servicing, maintenance, replacement, etc.). In one form, such counterbalance system includes shocks or struts, such as gas charged shocks that are connected to each driven gear and used to hold the driven gears in alignment/position. Spacers may also be used between the individual drive gears and/or the individual driven gears to ensure proper alignment, spacing and/or path of travel. In a preferred form, the spacers are made of a high density polyethylene or any other suitable plastic or metal material and are sized such that the spacer extends beyond the periphery of the drive gear and overlaps with at least a portion of the driven gear (e.g., into extending into the gap between the driven gears) to help space the driven gears as well as the drive gears.

Also disclosed is an adjustable arm and bed arm assembly which allows for fine adjustment and alignment of the bed arm assembly with respect to the arm. In the form illustrated, the arm defines threaded bores, such as tapped bores, and a bolt that passes through an opening defined by the bed arm bracket, a nut and is threaded into the threaded bores of the arm. The nuts location between the bed arm bracket and the arm allows the position of the bed arm assembly to be adjusted with respect to the arm to ensure proper alignment of the bed arm assembly and, specifically, the portion of the flexible bed associated therewith.

An integrated lift mechanism may also be provided with the material forming apparatus to allow the material forming apparatus to be used with a variety of different sized workpieces. In one form, the lift mechanism allows an upper portion of the material forming apparatus to be raised with respect to the base thereby elevating the height of the flexible bed so that larger workpieces can be formed and/or larger flexible beds used without causing the flexible bed and/or the workpieces from coming into contact with the floor or surface upon which the apparatus is mounted, or other obstruction. In a preferred form, the lift mechanism includes a chain driven sprockets that either drive an upper portion of the material forming apparatus upward with respect to the base of the apparatus or drive a lower portion of the material forming apparatus downward to raise the flexible bed of the apparatus. In one form, the lift mechanism includes an integral tension mechanism for tightening or loosening the sprocket chain and the lift mechanism is positioned either in or on an upper portion of the material forming apparatus out of the way of an operator and/or the remaining components of the apparatus (e.g., the drive and driven gears, arm shafts, arms, bed arm assemblies, clamps, etc.). Furthermore, in a preferred form, the apparatus housing is defined to telescope in response to the raising and lowering of the flexible bed with the lift mechanism so that the footprint of the apparatus is minimized and to prevent objects or foreign particles from interfering with the operation of the lift mechanism. In some forms, the apparatus may include alight or illumination device for illuminating at least a portion of the inner cavity of the housing of the material forming apparatus so that a user or operator can perform maintenance, service and/or replacement or repair work regardless of the lighting of the surrounding environment or environment wherein the apparatus is disposed. The apparatus may also define a window, door or access panel, cabinet and/or drawer for use by the operator/user.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a top plan view of a material forming apparatus in accordance with one embodiment of the present invention;

FIG. 2A illustrates a side elevation view of a material forming apparatus in accordance with one embodiment of the present invention;

FIG. 2B illustrates an enlarged side elevation view of the roller clamp of the material forming apparatus of FIG. 2A;

FIG. 3 illustrates a front elevation view of a material forming apparatus in accordance with one embodiment of the present invention;

FIG. 4 illustrates a front elevation view of a plurality of drive gears and a plurality of driven gears in accordance with one embodiment of the present invention;

FIG. 5 illustrates a front elevation view of a plurality of pivoting arms, a plurality of pneumatic clamps and one or more cranks of a material forming apparatus in use in accordance with one embodiment of the present invention;

FIG. 6A-B are top plan and front elevation views, respectively, of a material forming apparatus in accordance with another embodiment of the present invention;

FIG. 6C is a front elevation view of the material forming apparatus of FIGS. 6A-B illustrating the plurality of pivoting arms and clamps in use and forming or bending a workpiece or piece of material;

FIGS. 6D-E are side elevation and enlarged side elevation views, respectively, of the material forming apparatus of FIGS. 6A-B, with 6E illustrating the opposite side elevation view of the bed arm assembly which is a mirror image of the bed arm assembly illustrated in FIG. 6D;

FIGS. 7A-B are top plan and front elevation views, respectively, of the gear array or assembly used in the material forming apparatus of FIGS. 6A-B;

FIGS. 8A-D are perspective, side elevation, top plan and front elevation views, respectively, of an alternate material forming apparatus in accordance with the invention and illustrating the work bed in an initial or pre-forming position, the other side elevation view being a mirror image of FIG. 8B;

FIGS. 9A-B are perspective views of the gear array, arm and bed arm assembly illustrated in FIGS. 8A-D, with FIG. 9B illustrating an isolated gear set, arm and bed arm assembly to simplify the illustration;

FIGS. 10A-B are perspective views of a gear sled that may be used in conjunction with a material forming apparatus in accordance with the invention, with FIG. 10A illustrating spacers present between, the individual gears and FIG. 10B illustrating the assembly without the spacers to simplify the illustration;

FIGS. 11A-B are perspective and front elevation views, respectively, of adjustable gear assemblies that may be used in conjunction with a material forming apparatus in accordance with the invention, illustrating both adjustable drive gears and adjustable driven gears;

FIG. 11C is a perspective view of the adjustable gear assemblies of FIGS. 11A-B illustrating how the adjustable gear assemblies may be connected to a gear sled in accordance with the invention;

FIG. 12 is a perspective view of an alternate gear assembly in accordance with another aspect of the invention illustrating multiple drive gears but only one driven gear in order to simplify the illustration;

FIGS. 13A-B are perspective and enlarged perspective views of a plurality of arm and bed arm assemblies in accordance with the invention which illustrate an alternate adjustable bed arm mechanism that may be used in accordance with a material forming apparatus to allow the bed arms to be adjusted and/or calibrated;

FIGS. 14A-C are perspective, top plan and enlarged perspective views of a lift mechanism for a material forming apparatus in accordance with the invention, with FIG. 14C illustrating an enlarged perspective view of the lift mechanism and with a partial cutaway showing an internal acme screw that is rotated to raise and/or lower the lift mechanism;

FIGS. 15A-B are front and rear perspective views, respectively, of an alternate material forming apparatus in accordance with the invention illustrating the outer housing panels removed in FIG. 15B to simply the illustration and show items that are not visible when the housing panels are in place; and

FIGS. 16A-B are perspective views illustrating a gear sled in accordance with the invention with FIG. 16A further illustrating a motor and transmission connecting the motor to a drive shaft connected to a plurality of drive gears and FIG. 16B illustrating an adjustable gear sled and tensioning mechanism capable of moving the drive gears into and out of engagement with the driven gears.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

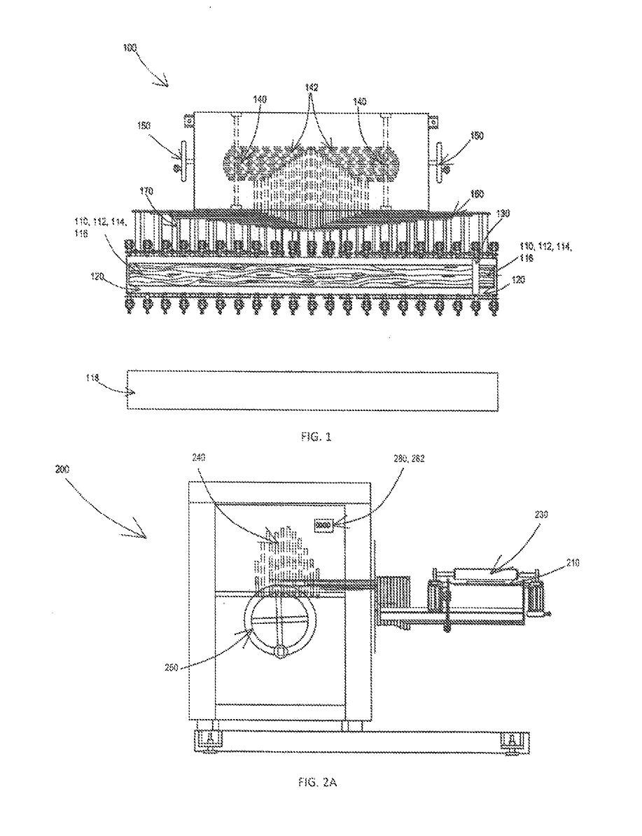

FIG. 1 illustrates a top view of a material forming apparatus 100, in accordance with one embodiment of the present invention.

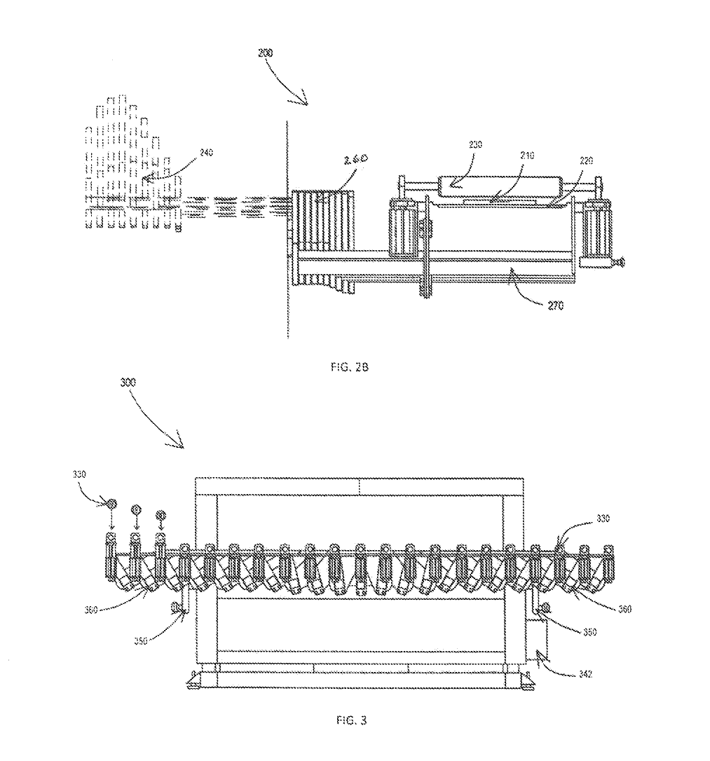

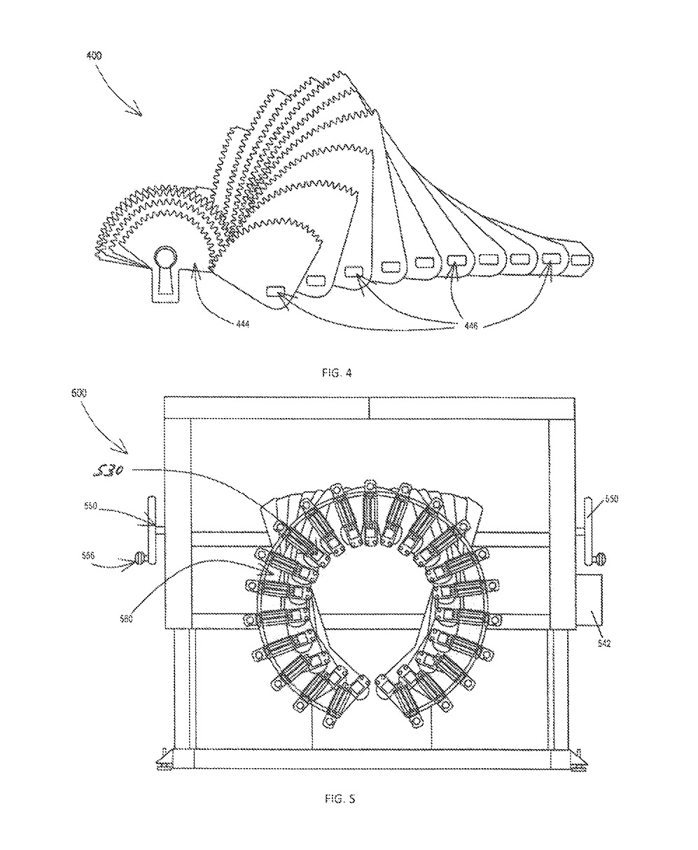

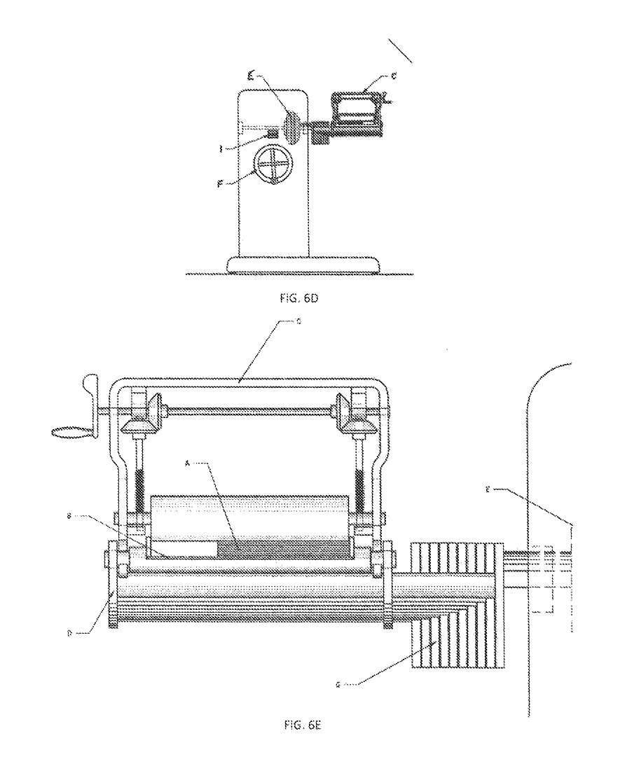

The material forming apparatus 100 includes a piece of material 110, a flexible bed 120, a plurality of roller clamps 130, a plurality of drive gears 140, one or more cranks 150, a plurality of pivoting arms 160 and a plurality of bed arms 170. The piece of material 110 can include a piece of laminated wood 112, a piece of thermoform plastic 114, a piece of acrylic 116 or other suitable material. A cover sheet 118 made of plastic. material or other suitable material that is approximately in the range of one-eighth of an inch (⅛″) to one-fourth of an inch (¼″) in thickness is placed over the piece of material 110 to provide protection to the piece of material 110. The flexible bed 120 receives the piece of material 110 that is removably placed on the flexible bed 120 to be shaped. The flexible bed 120 is typically made of plastic but can be made of any suitable material. The flexible bed 120 is approximately one-fourth inch (¼″) in thickness although the flexible bed 120 can be any suitable thickness. The roller clamps 130 are positioned above the piece of material 110 and the flexible bed 120 to assist shaping the piece of material 110. Additional details regarding the roller clamps 130 are described in subsequent FIGS. 2B, 3, and 5. The drive gears 140 are rotated to assist shaping the piece of material 110. Additional details regarding the drive gears 140 are described in subsequent FIGS. 2A, 2B and 4. The one or more cranks 150 is/are rotated to provide power to rotate the drive gears 140. The one or more cranks 150 can be one or more manual cranks 152 or one or more motorized cranks 154. The pivoting arms 160 are rotated by the rotation of the drive gears 140 and move the roller clamps 130 to force the flexible bed 120 and the piece of material 110 downward to form a reducing, concentric arc radius. Additional details regarding the pivoting arms 160 are described in subsequent FIGS. 2B, 3, 4 and 5. The plurality of bed arms 170 receive the roller clamps 130 that are placed over the piece of material 110 by locking onto the bed arms 170.

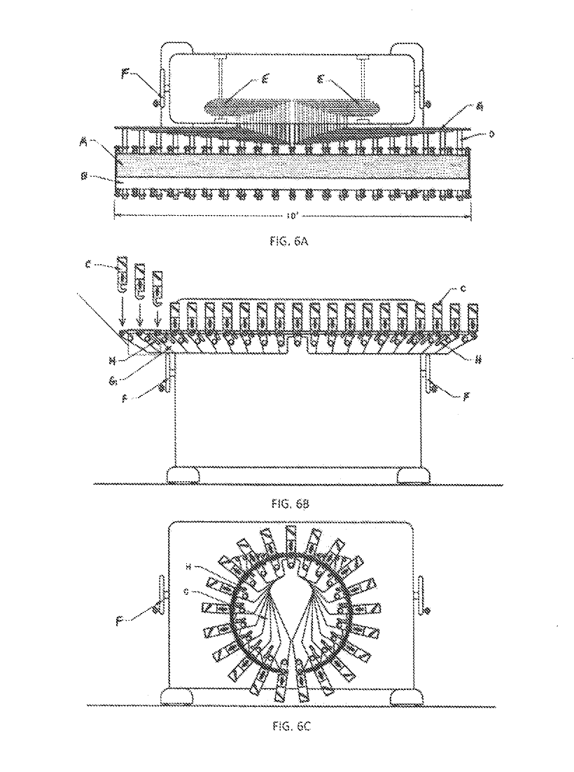

FIG. 2A illustrates a side view of a material forming apparatus 200, in accordance with one embodiment of the present invention. The material forming apparatus 200 illustrated in FIG. 2A is similar to the material forming apparatus 100 illustrated and described in FIG. 1 and its description. The material forming apparatus 200 illustrated in FIG. 2A includes one or more cranks 250, a numerical display 280, a plurality of drive gears 240, a roller clamp 230 and a piece of material 210. The one or more cranks 250, drive gears 240 and piece of material 210 are similar to the one or more cranks 150, drive gears 140 and piece of material 110 illustrated and described in FIG. 1 and its description, respectively, and will therefore be referenced using similar two digit reference numerals but having the prefix “2” instead of “1”. The numerical display 280 is typically a digital display 282 that indicates when a desired predetermined length of a radius of the piece of material 210 is reached. The roller clamp 230 is placed over the piece of material 210 to assist shaping the piece of material 210. Additional details regarding the roller clamp 240 are described in subsequent FIGS. 2B and 3.

FIG. 2B illustrates an enlarged side elevation view of roller clamp 230 of the material forming apparatus 200 of FIG. 2A, in accordance with one aspect of the present invention.

The material forming apparatus 200 illustrated and described in FIG. 2B is similar to the material forming apparatus 100 described in FIG. 1 and its description. The material forming apparatus 200 illustrated and described in FIG. 2B includes the piece of material 210, the flexible bed 220, the roller clamp 230, the plurality of bed arms 270, the drive gears 240 and the plurality of pivoting arms 260 that are similar to the piece of material 110, the flexible bed 120, the plurality of roller clamps 130, the plurality of bed arms 110, and the plurality of pivoting arms 160 that are described and illustrated in FIG. 1 and its descriptions.

FIG. 3 illustrates a front view of a material forming apparatus 300, in accordance with one embodiment of the present invention.

The material forming apparatus 300 described and illustrated in FIG. 3 is similar to the material forming apparatus 100, 200 illustrated and described in FIGS. 1, 2A and 2B and will thus use the same two digit reference numerals but prefixed with a “3” merely to distinguish one embodiment from another. The material forming apparatus 300 includes a plurality of roller clamps 330, a plurality of pivoting arms 360 and one or more cranks 350. The roller clamps 330, the pivoting arms 360 and the one or more cranks 350 illustrated and described in FIG. 3 are similar to the roller clamps 230, the pivoting arms 260 and the one or more cranks 250 illustrated and described in FIGS. 2A and 2B. The roller clamps 330 are placed over the piece of material (FIG. 2B, 210) by locking onto the bed arms (FIG. 2B, 270). The roller clamps 330 are closed down loosely to make contact with the piece of material 210. The drive gears 240 are rotated simultaneously by the one or more cranks 350 or a suitable motor 342, initiating rotation of each pivoting arm 360 independent of each other, at the rotation rate determined by a gear-ratio of each pivoting arm 360. The pivoting arms 360 move the bed arm 270 and the roller-clamp 330 forcing the flexible bed (FIG. 2B, 220) into an arc and the piece of material 210 to form a reducing, concentric, arc radius. The operator stops the rotation when the desired predetermined radius length is reached, indicated on the numerical display (FIG. 2A, 280). The roller clamps 330 are tightened down to hold the piece of material 210 together until a glue utilized to secure the piece of material 210 together dries or the piece of material 210 cools. The roller clamps 330 can be removed along with the newly formed piece of material 210 and the material forming apparatus 300 is ready to form a new part.

FIG. 4 illustrates a front elevation view of a plurality of drive gears 444 and a plurality of driven gears 446 of a material forming apparatus 400, in accordance with one embodiment of the present invention.

The plurality of drive gears 444 and the plurality of driven gears 446 illustrated and described in FIG. 4 are similar to the plurality of drive gears 140, 240 and 340 illustrated and described in FIGS. 1, 2B and 3. Thus, in keeping with the above, similar two digit reference numerals will be used with the addition of the prefix “4” to distinguish one embodiment from others. The plurality of drive gears 444 rotate and are engaged with the driven gears 446 and rotate the driven gears 446 and pivoting arms as previously illustrated and described with respect to drive gears 340 and pivoting arms 360 in FIG. 3 and its description.

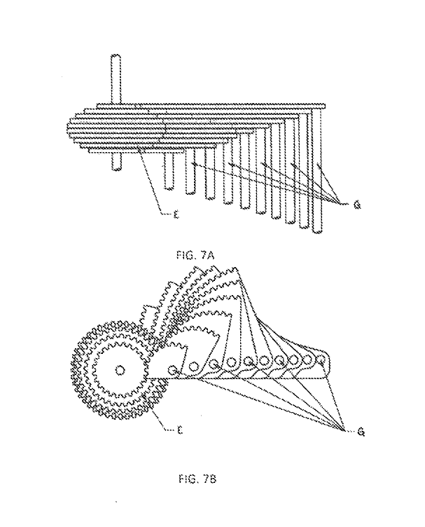

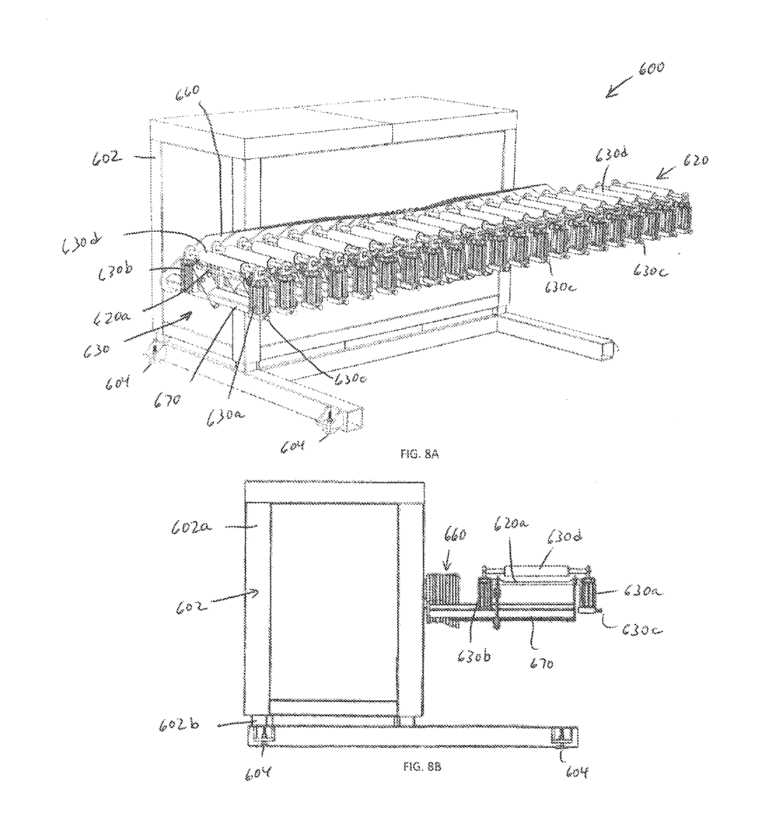

FIG. 5 illustrates a front perspective view of a plurality of pivoting arms 560, a plurality of clamps 530 and one or more cranks 550 of a material forming apparatus 500 in use, in accordance with one embodiment of the present invention.

The plurality of pivoting arms 560 and the one or more cranks 550 of the material forming apparatus 500 illustrated and described in FIG. 5 are similar to the plurality of pivoting arms 360 and one or more cranks 350 of material forming apparatus 300 illustrated and described in FIG. 3 and its description. The clamps 530 are similar to the roller clamps 330 illustrated and described in FIG. 3 except that the roller clamps 530 illustrated and described in FIG. 5 and its description are pneumatic roller clamps 532. The one or more cranks 550 illustrated and described in FIG. 5 also have a grasping knob 556.

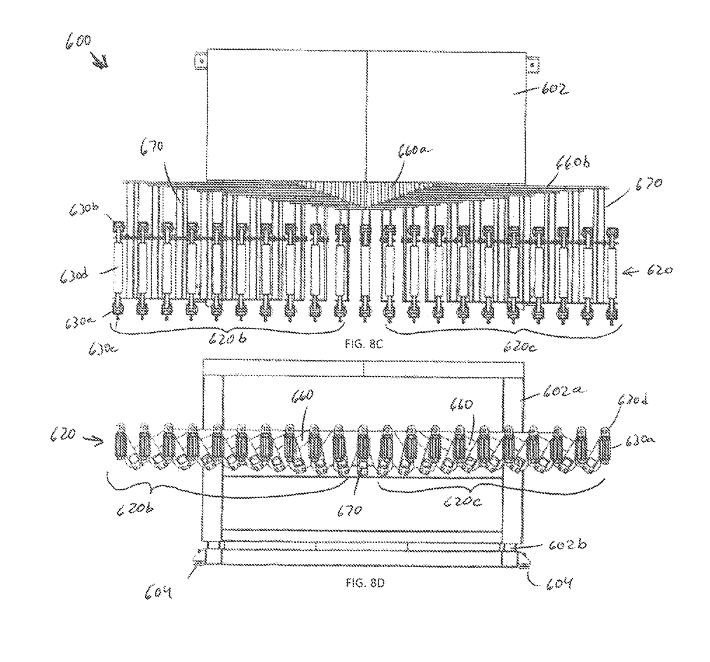

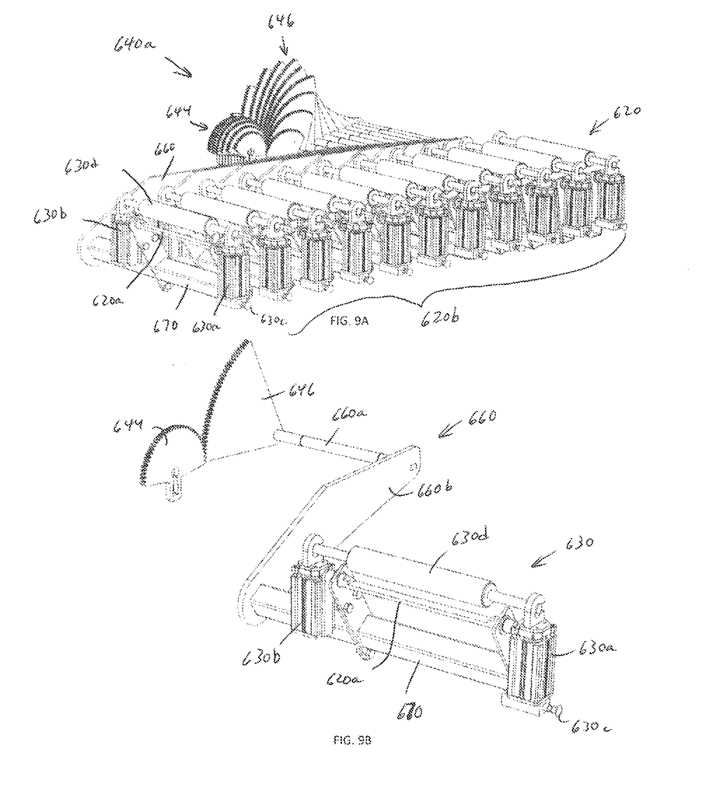

An alternate forming machine in accordance with the invention is illustrated in FIGS. 6A-7B. Like the above embodiments, the forming machine of FIGS. 6A-7B can be dialed into virtually unlimited radii to provide a platform to form various materials into a specific radius shape. Thus saving time and money by eliminating the need to build fixed radius fixtures that only work for a specific shape. For example, the bending machine of FIGS. 6A-7B can be used to form lamented wood for curved moldings, panels, and all other wood product, but is not limited to any other material that uses fixed forms to mold to, through the use of fixtures and clamps. Also it can be used to thermoform plastics and acrylics to a desired radius by providing a platform to form to after being heated to the specified temperature.

In the form illustrated in FIGS. 6A-7B, multiple, thin layers of wood, sandwiched with glue, and stacked together (or other material which requires forming) (A), is placed on bed (B). A thin cover sheet (e.g., ⅛^{th} inch to ¼^{th} inch plastic) is then placed over the material. Then a clamp, such as roller clamp (C), is placed over the material (A) by locking onto the bed arms (D). Roller-clamps (C) are closed down loosely to make contact with the material (A). Drive gears (E) are rotated simultaneously, by means of manual crank (F) or motor, initiating rotation of each pivoting arm (G) independent of each other, at the rotation rate determined by the gear-ratio of each arm. Pivoting arms (G) move the bed arm/roller-clamp assembly (C)/(D) with the assistance of roller cams (H) between pivoting arms (G) forcing the metal bed downward (B), and the attached material stack (A) to form a reducing, concentric, arc radius. The operator stops the rotation when the desired radius is reached, indicated on the numerical display (I). Now the clamps are tightened down to hold the material until the glue dries or the materials cools. At this time, the clamps can be removed along with the newly-formed material, and now ready to form a new part.

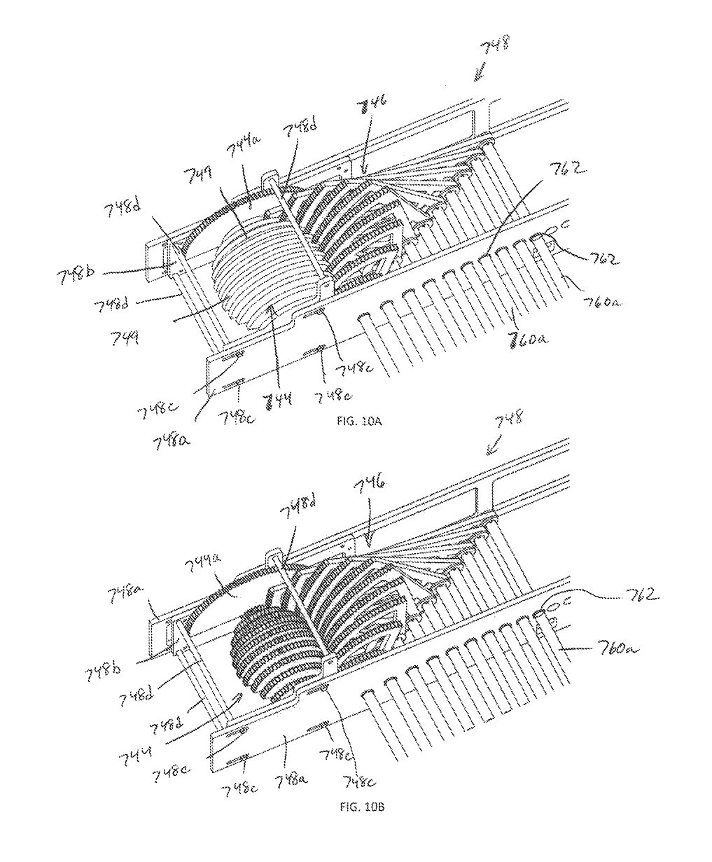

Yet another embodiment of a material forming apparatus in accordance with the invention is illustrated in FIGS. 8A-D and, in keeping with the above practice, is referenced using the same later two-digit reference numeral but using the prefix “6” to distinguish one embodiment from the others. Thus, the apparatus in FIGS. 8A-D will be referred to generally by reference numeral 600. In the form illustrated, the material forming apparatus 600 includes a housing 602, flexible bed 620, plurality of clamps, such as roller clamps 630, connected to a plurality of bed arms 670, which in turn are connected to pivoting arms 660. The housing 602 has an upper portion 602a and a lower portion or base portion 602b. The lower portion 602b includes adjustable feet or pads 604 and extends out under the flexible bed 620 in order to balance the apparatus 600. In a preferred form, the lower portion 602b forms a frame or skeleton that the upper portion 602a fits over and together the upper and lower portion 602a, 602b define a cavity within which the gear assembly is disposed for the flexible bed 620.

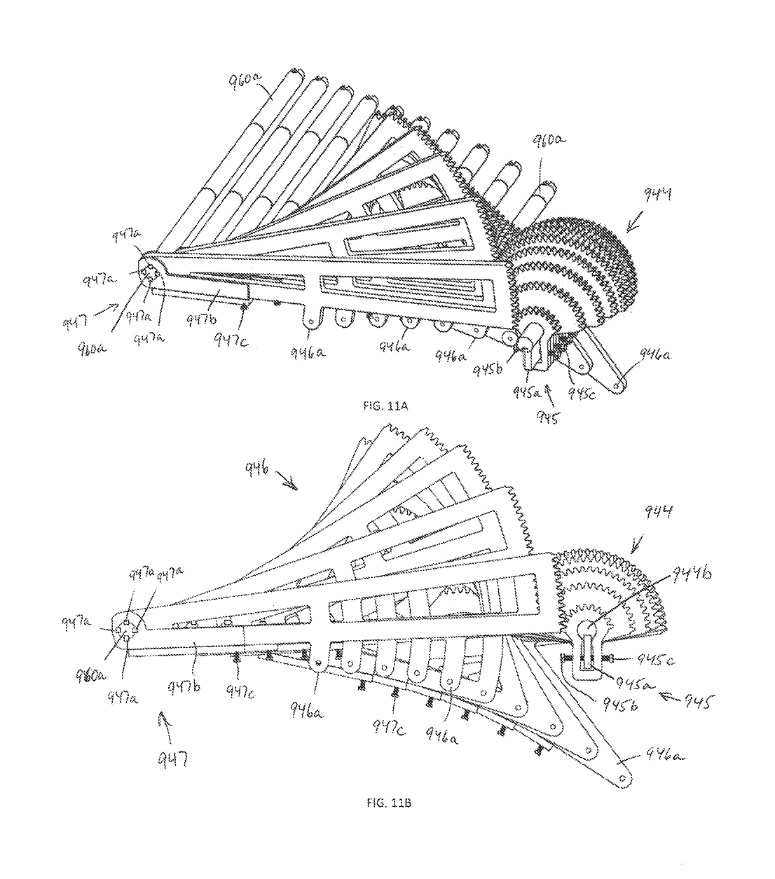

In the form illustrated, the flexible bed 620 includes twenty-one bed arms with power clamps, such as pneumatically driven roller clamps 630. Each clamp 630 includes two pneumatic cylinders 630a, 630b with an air valve operator or actuator 630c. As with earlier embodiments, the rollers 630d are removed from each clamp 630 and a first flexible cover sheet is laid over the individual bed brackets or shaft 620a of bed arms 670. The flexible cover may be made of any flexible material but wood or plastic is preferred and preferably the first cover will have a thickness of one-fourth an inch (¼″) or less. As best illustrated in FIG. 9B, the bed shaft 620a will preferably have a stepped configuration with a lowermost portion designed to receive the first cover and then a stepped shoulder being provided to accommodate the workpiece on top of the first cover. The stepped configuration helps hold the cover and/or workpiece in position and reduces the risk of lateral movement of either during the forming process. Next the desired workpiece or material to be formed is placed on the first cover sheet (which may be a single layered piece like a plastic sheet or multi-layered pieces like laminated wood workpieces) and then a second cover sheet (see 100 in FIG. 1) is placed over the workpiece and the rollers 630d are reinstalled on each power clamp 630. The operator will then actuate each valve operator 630c to clamp down each roller on the workpiece and cover sheets. The cover sheets being used to protect the workpiece from scrapes, nicks, marring, etc. The bed arms 670 are then pivoted into desired positions to form the desired bend in the workpiece via the gear assembly disposed within housing 602. In a preferred form, two separate gear arrays will be used to drive opposite sides 620b, 620c of the flexible bed 620 as will be discussed further with respect to FIGS. 9A-B.

While twenty-one bed arms and pneumatically driven roller clamps have been illustrated, it should be understood that fewer or more bed arms and clamps may be used as needed for a particular task and/or as desired. For example, if the apparatus 600 will always be used with smaller or shorter workpieces, fewer bed arms and clamps may be required and therefore used for the apparatus. Conversely, if the apparatus 600 will always be used with larger or longer workpieces, more bed arms and clamps may be desired and therefore used. Similarly, it should be understood that the material forming apparatus may be provided in either a stationary power tool form (e.g., closed base, open based or stand, etc.) or a benchtop form (resting on a workbench, stand or provided in a portable version such as without limitation with integral wheels etc.). For example, if the apparatus is to be used with larger workpieces or by professional shops, the apparatus will likely be provided in a stationary power tool form and may include a lift mechanism as will be discussed below. Conversely, if the apparatus is to be used with smaller workpieces or by hobbyists, it will likely be provided in a more portable version such as a benchtop version or a contractor stand type version. In addition, although pneumatic roller clamps have been illustrated, it should be understood that in alternate embodiment any number of different clamps may be used, including without limitation manually operated clamps (see FIG. 6E above), powered clamps, etc. In the form illustrated, twenty-one bed arms and clamps were selected to provide for 10 pivotal bed arms and clamps on each side of the flexible bed 620a, 620b, with the center bed arm and clamp remaining stationary.

In FIGS. 9A-B a first gear array 640a is illustrated showing how the gears and bed arms 670 of the first side of the flexible bed 620b are arranged, with FIG. 9B isolating a single gear set and bed arm for simplicity. Like the embodiments discussed above, gear array 640a includes a plurality of drive gears 644 that engage and drive corresponding driven gears 646. Each drive gear 644 is keyed to a drive shaft operated by an actuator such as a hand crank or spindle (e.g., 350, FIG. 3) or motor (e.g., 342, FIG. 3) and at least one of the drive gear 644 and driven gear 646 are non-circular or out of round so that pitch continuously changes as the drive gear 644 engages and drives the driven gear 646. In a preferred form, at least the driven gear 646 is non-circular or out of round such as the eccentric spur or cam gear illustrated. In some forms, both the drive gear 644 and driven gear 646 will be non-circular or out of round in order to provide an ever changing pitch.

As illustrated in FIGS. 9A-B, the driven gear is connected to a pivoting arm or gear shaft 660a which in turn is connected to the arm 660b and causes the arm 660b to pivot along with the arm shaft 660a. Together the arm shaft 660a and arm 660b form the pivoting arm 660 which connects the gear array 640 to the bed arm 670. In the form illustrated in FIGS. 9A-B, the first end of arm shaft 660a is connected to the driven gear 646 and the second end of the arm shaft 660b is tapered and/or keyed to fit into an opening defined by the arm 660b and is fastened to the arm 660b via a weld. As illustrated in FIG. 9B, the distal end of arm shaft 660a is tapered and/or keyed down to a generally rectangular shape (which may or may not include rounded opposed ends) that mate with a recess of similar shape to key the shaft 660a and arm 660b together before welding. The first end of the arm shaft 660a may also be keyed to the driven gear 646 using a similar shape as illustrated in FIG. 4 above and as will be discussed further below. It should be understood, however, that in alternate forms, a removable form of attachment may be used to connect the arm shaft 660a to arm 660b, such as a fastener (e.g., bolt, screw, rivet, etc.). In still other forms, the arm shaft 660a and arm 660b may alternatively be molded or cast as an integral piece that does not require further connection of the arm shaft 660a to the arm 660b.

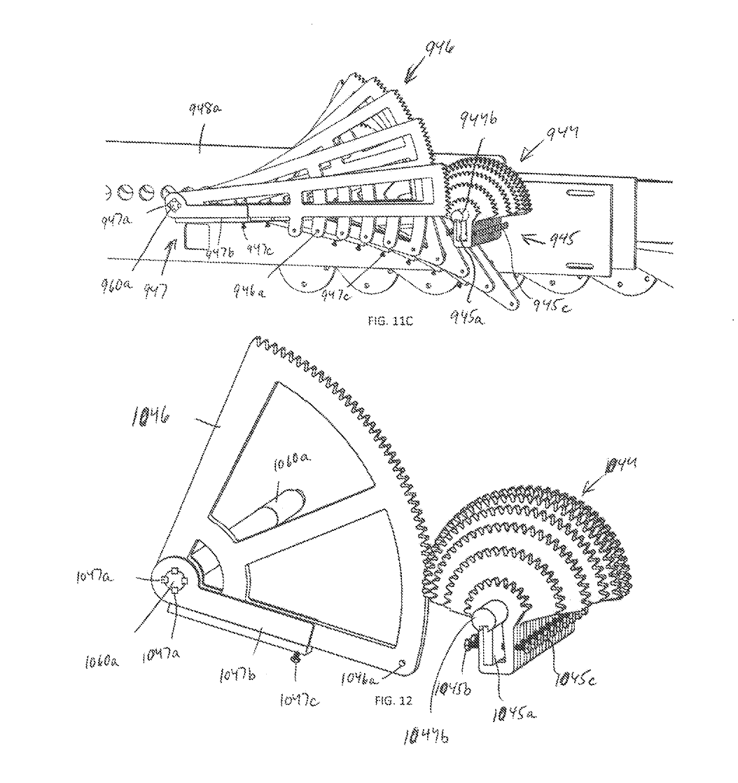

Turning now to FIGS. 10A-B, in which there are illustrated additional features in accordance with the invention that may be utilized with any and all embodiments discussed herein. In keeping with the above practice, items that are similar to those discussed above will use the same latter two-digit reference numeral but adding the prefix “7” to distinguish one embodiment from the others. In these figures, a gear sled 748 is illustrated that can be used to slide the plurality of drive gears 744 into and out of engagement with the driven gears 746, and spacers 749 are illustrated which may be used to help align or space the drive gears 744 and/or the driven gears 746. With respect to the latter concept, FIG. 10A illustrates the plurality of drive gears 744 spaced apart by spacers 749. In the form illustrated, the spacer not only helps maintain the appropriate spacing between drive gears 744, but also provides a buffer between the gears 744 so that one gear does not wear on another. In a preferred form, a high density polyethylene or any other suitable plastic material may be used for the spacers 749 and the spacers 749 may be sized such that the spacer extends beyond the periphery of the drive gear 744 and overlaps with at least a portion of the driven gear 746 (e.g., extending into the gap between the driven gears 746) to help space and/or align the driven gears 746 as well as the drive gears 744. One benefit to plastic spacers 749 is that wear on the plastic spacer caused by movement of the metal gears 744, 746 should be minimal and not problematic. Alternatively, however, other materials may be used for spacer 749 such as metal, wood, ceramic, etc.

In addition to spacers 749, FIGS. 10A-B further illustrate an optional gear sled 748 that may be used to align and slide the plurality of drive gears 744 into and out of engagement with the driven gears 746. In the form illustrated, sled 748 includes an outer frame (also known as the shaft housing) 748a and an inner frame 748b that is releasably connected to the outer frame 748a so that the inner frame 748b can be moved and secured between an engaged position wherein the drive gears 744 are aligned and engaged with the driven gears 746, or a disengaged position wherein the drive gears 744 are disengaged from the driven gears 746. In the form illustrated, the outer frame 748a preferably defines slots, channels or guides that fasteners, such as bolts 748c, can be disposed within to releasably connect the inner frame 748b to the outer frame 748a. Thus, the fastener 748c can also be moved between a secured position wherein the inner and outer frames 748b, 748a cannot be moved with respect to one another and an unsecured position wherein the inner frame 748b can be moved with respect to the outer frame 748a. Thus, when bolts 748c and in the unsecured position and the inner frame 748b can be freely moveable within the outer frame 748a for the length of the slots defined by outer frame 748b. It may be desirable to move the inner sled frame 748b away from the driven gears 746 to disengage the drive gears 744 from the driven gears 746 to allow for service or maintenance to be performed on the apparatus or its gears 744, 746 such as realignment, etc. or if it is desirable to only have one gear array operational such as if only one end of the flexible bed 720a 720b is to be operable. The inner sled frame 748b can alternatively be moved toward the driven gears 746 in order to engage the drive gears 744 and driven gears 746 so that the apparatus can be used for normal operation.

In the form illustrated in FIGS. 10A-B, the fastener 748c and inner sled frame 748b are further moveable to a fully released position wherein the fasteners 748c are removed from the inner sled frame 748b so that the inner sled frame 748b can be pulled out of the outer led frame. In a preferred form, the inner sled frame 748b has crossbars 748d for maintaining the outer walls of the sled 748b in position so that the drive gears 744 maintain their alignment and can be lifted out of the outer sled frame or shaft housing 748a using one or more of the crossbars 748d as a handle or handles. The drive gears further include a main drive gear 744a which is driven by the actuator to rotate the drive shaft connected to the remaining drive gears 744. As also is visible in FIGS. 10A-B, the outer sled frame or shaft housing 748a preferably defines a plurality of openings in a sidewall thereof for receiving corresponding arm shafts 760a. In a preferred form, the plurality of outer sled frame openings help to align the arm shafts 760a and, thus, the connected arms and bed arms to ensure smooth rotation of same. In one form, the plurality of openings in outer sled frame 748a may also include friction reducing mechanisms, such as bushings 762. In other forms, bearings or other friction reducing mechanisms may be used in place of bushings 762 or in addition to bushings 762.

An optional alternate sled mechanism is illustrated in FIGS. 16A-B. Items similar to those discussed above will be referenced using the same latter two-digit reference numeral, but adding the prefix “8” to distinguish one embodiment from the others. In the form illustrated in FIGS. 16A-B, the inner and outer sleds 848b, 848a make the drive gears 844 moveable into and out of engagement with the driven gears 846 similar to that discussed above with respect to FIGS. 10A-B, however, in addition gear sled assembly 848 of FIGS. 16A-B includes a tensioning mechanism 848e that allows tension to be applied to the inner gear sled 848b in order to ensure that a solid engagement is made between the drive gears 844 and the driven gears 846 when the inner gear sled 848b is moved into its gear engaging position. Once tension is applied via the tensioning mechanism 848e, fasteners 848c may be moved to their sled securing position to hold the inner sled 848b in place with respect to the outer sled 848a and the driven gears 846. In the form illustrated, the tensioning mechanism 848e comprises bolts that are thread through threaded bores in an outer wall of the outer sled 848a which are then thread into engagement with an outer surface of the inner sled 848b which is parallel to the outer surface of the outer sled 848a which defines the threaded bores. This allows two perpendicular forces to be applied to the gear sled 848 (i.e., x and y forces or lateral and longitudinal forces) to ensure that the inner sled 848b keeps the drive gears 844 properly engaged with the driven gears 846 which is preferable over the single lateral force design of FIGS. 10A-B.

The outer sled includes dual walls in front of the gear assembly 840 that each define a plurality of openings through which respect arm shafts 860a are disposed. As with the prior embodiment of FIGS. 10A-B, at least one of the dual walls of the outer sled 848a will include friction reduction mechanism, such as bushings 862. In addition, in FIG. 16A a motor 842 is illustrated as the actuator for the gear array 840a and shows the motor output shaft drive sprocket engaging the main drive gear 844a indicating that an automated material forming apparatus 800 is provided.

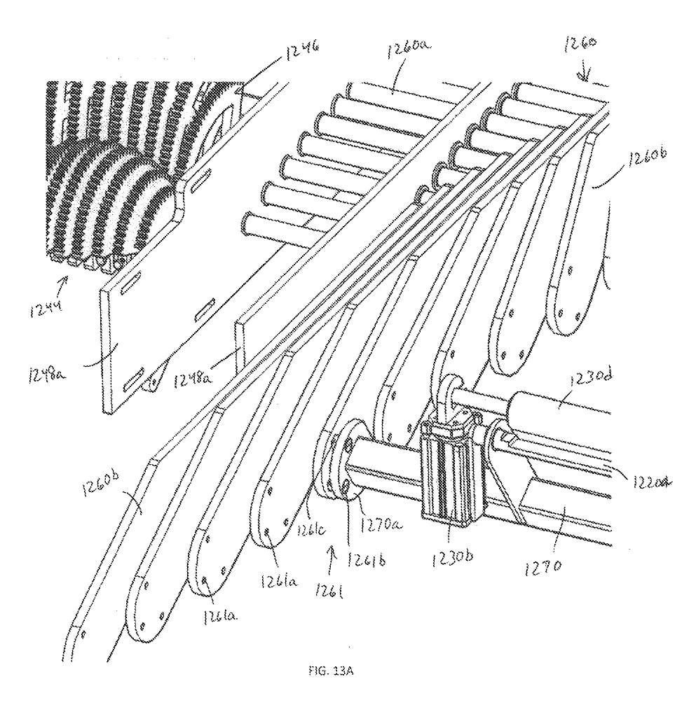

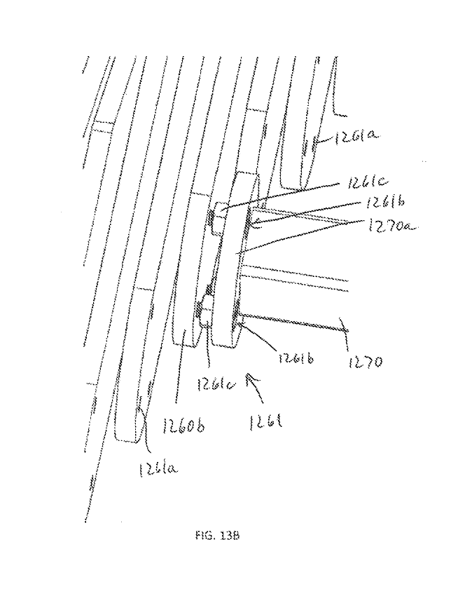

In FIGS. 11A-C, another optional feature that can be used with any embodiment disclosed herein includes drive gears and/or driven gears wherein at least one of the drive gear or driven gear are adjustable to prevent slippage and/or to allow for fine adjustment or alignment of the gears and/or their associate arm or bed arm assemblies. In keeping with the above practice, items that are similar in these figures will use the same latter two-digit reference numeral, but use the prefix “9” to distinguish one embodiment from others. In the form illustrated in FIGS. 11A-C, the second or left-side gear array 940b is illustrated (which would move the right side of flexible table (see 620c, FIG. 8C for example). In this embodiment, each drive gear 944 is keyed with an adjustable key mechanism 945 that allows for independent alignment of the arm 960 and/or bed arm assembly associate with a particular drive gear 944 and key mechanism 945. In the form illustrated, each drive gears defines a slot with a rounded opening for receiving drive shaft 944b and an elongated opening or protrusion for receiving key member 945a, which is a rectangular bar that fits within a downward facing recess defined by the drive shaft 944b and the elongated opening of drive gears 944. The elongated opening has a generally wedge shape or frusto conical shape with a narrower neck portion and a wider lower or base portion giving the individual drive gears 944 play with respect to the key member 945a. The key mechanism further includes alignment pins, such as bolts 945b, 945c, which may be used to make fine adjustments to the drive gear 944 with respect to drive shaft 944b so that the corresponding bed arm is positioned in the desired alignment and/or orientation (e.g., via drive shaft or arm shaft 960a and arm). Thus, alignment mechanism 945 allows the alignment of each drive gear 944 and corresponding bed arm 970 to be fine-tuned in this manner.

In addition, in FIGS. 11A-C, each driven gear 946 also preferably includes an adjustable gear lock assembly 947 that allows the driven gear 946 to be adjusted to prevent slippage or backlash between the arm shaft 960a and the driven gear 946. In one form, the driven gear 946 is keyed to the arm shaft or driven shaft 960a via a plurality of fingers 947a that are positioned or disposed within recesses defined by the arm shaft 960a, the corresponding opening in driven gear 946 for arm shaft 960a and the gear lock assembly 947, itself. In the form illustrated, the arm shaft openings in driven gear 946 and gear lock assembly 947 are generally circular in cross-section with opposed recesses in the form of a cross extending in from the generally circular opening. These three structures align to define finger openings within which the fingers 947a are disposed to key the driven gear 946 and the gear lock assembly 947 to the arm shaft 960a. The gear lock assembly 947 further includes a sleeve portion 947b that forms a generally U-shaped cross section and extends along at least a portion of the side walls and bottom surface of the driven gears 946 and includes an adjustable screw 947c for eliminating any backlash between the keyed portions of the driven gear 946 and the arm shaft 960a. Preferably the key will include a plurality of key slots recessed in the arm shaft 960a and arm shaft opening of driven gear 946 with individual keys 947a inserted into the respective key slots defined by the aligned recesses of the arm shaft 960a and driven gear 946 so that the driven gear is securely connected to the arm shaft 960a and ultimately the bed arm 970 associated or coupled to same. In a preferred form, friction reducing mechanisms, such as bushings, are also disposed in the plurality of openings defined by the housing through which the arm shaft 960a will be disposed in order to align the shaft with the respective openings in the housing of the material forming apparatus to prevent wear on the arm shaft and reduce friction related to the rotation of the arm shaft 960a. In alternate forms, other friction reducing mechanisms, such as ball bearings, may be used. As mentioned above, the arm shaft 960, driven gear 946 and gear lock assembly 947 may be designed with alternate keying structures (see shape of the arm shaft opening in driven gear 446 of FIG. 4 for example).

As also mentioned above with respect to FIG. 9B, in a preferred form, the distal end of the arm shaft 960a in FIGS. 11A-C will be tapered and/or keyed to the arm in order to maintain proper alignment of the arm shaft and arm. The arm shaft 960a is also preferably fastened to the arm to ensure movement of the arm shaft 960a translates into a corresponding and repeatable rotational movement of the arm. In the form illustrated this is accomplished via a weld or other permanent connection (e.g., such as by casting, molding or pressing the pieces from an integral material), however, in alternate embodiments, the arm shaft 960a may be removably connected to the arm if desired or needed.

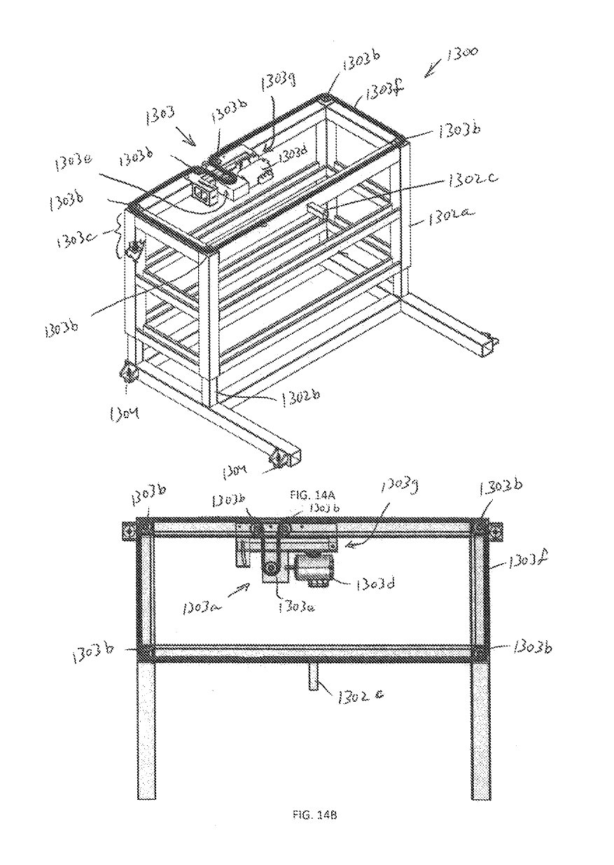

In FIG. 12 another embodiment of an adjustable key mechanism for drive gears and adjustable gear lock assembly for driven gears is illustrated. In keeping with the above, items in this embodiment which are similar to those discussed above will use a common latter two-digit reference numeral, but apply the prefix “10” to distinguish one embodiment from others. In the form illustrated, each drive gear 1044 is keyed with an adjustable key mechanism 1045 that allows for independent alignment of the arm 1060 and/or bed arm assembly associate with a particular drive gear 1044 by adjusting the key mechanism 1045 and, specifically, the driven gear's positioning with respect to key member 1045a via screws 1045b, 1045c in a manner similar to that discussed above with respect to FIGS. 11A-C. Thus, the key mechanism 1045 may be used to make fine adjustments to the drive gear 1044 with respect to drive shaft 1044b so that the corresponding bed arm is positioned in the desired alignment and/or orientation (e.g., via drive shaft or arm shaft 1060a and arm). Thus, alignment mechanism 1045 similarly allows the alignment of each drive gear 1044 and corresponding bed arm to be fine-tuned in a manner similar to the previously discussed adjustable key mechanism 945 in FIGS. 11A-C.

In FIG. 12, a single driven gear 1046 has been isolated and illustrated to make it easier to see the adjustable gear lock 1047 and particularly the U-shaped sleeve nature of same. In the form illustrated, the driven gear 1046 and adjustable gear lock 1047 are keyed to the arm shaft 1060a in a manner similar to that discussed above with respect to FIGS. 11A-C (e.g., with fingers 1047a being inserted into aligned recesses in the arm shaft 1060a, driven gear 1046 and adjustable gear lock 1047). The adjustable gear lock 1047 further defines a rounded end defining the openings through which the arm shaft 1060a and fingers 1047a are disposed and has an elongated sleeve 1047b extending therefrom and having a generally U-shaped cross section that allows the sleeve 1047b to extend across the bottom of the driven gear 1046 and up at least a portion of the sides or sidewalls of the driven gear 1046. The adjustable gear lock 1047 further includes a thickened lower wall portion (e.g., thickened with respect to the other wall portions of the sleeve 1047 and/or entire gear lock 1047) that is positioned below the driven gear 1046 to support the driven gear 1046 and to define a threaded bore or contain a threaded boss or sleeve through which screw or bolt 1047c is disposed and may be tightened to drive the driven gear 1046 against its keyed fingers 1047a to eliminate slippage and/or backlash between the arm shaft 1060a and driven gear 1046.

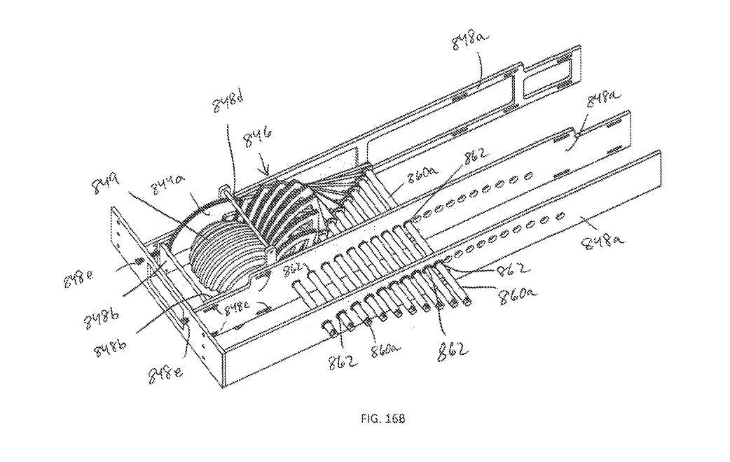

Another item in accordance with the invention disclosed herein for use with any embodiment of the material forming apparatus is a counterbalancing system for removing strain from the drive system (e.g., motor, drive shaft, gears, rotating arms and bed arms, etc.) to assist the system in operating without needless strain or stress. The counterbalancing system further helps aligning and maintaining the position of the driven gears with their respective drive gears so that alignment is maintained even when the drive gears are disengaged from their respective driven gears (e.g., such as for servicing, maintenance, replacement, etc.). One form of such a counterbalancing system is illustrated in FIG. 15B. In keeping with prior form, items that are similar to those discussed above will utilize the same latter two-digit reference numeral but add prefix “11” to distinguish one embodiment from the others. Thus, in FIG. 15B, the first gear array is referenced by reference numeral 1140a and the second gear array is referenced by 1140b, and the apparatus is referred to generally by 1100. In this form, the counterbalance system includes shocks or struts 1184, such as gas charged shocks that are connected to each driven gear 1146 and used to hold the driven gears 1146 in alignment/position. More particularly, and as illustrated in the gear systems of FIGS. 11A-12 and 15B, the driven gears preferably include a bore (see 946a in FIGS. 11A-C, 1046a in FIGS. 12 and 1146a in FIG. 15B) which a distal end of the counterbalance strut 1184 is connected to. The opposite end of the counterbalance mechanism 1184 is connected to a cross beam of the upper frame of the apparatus 1100 so that the counterbalance mechanism 1184 raises and lowers with the gear arrays 1140a, 1140b. In the form illustrated, the counterbalance mechanism 1184 is a pressurized nitrogen gas filled strut, however, in alternate embodiments it should be understood that other struts or similar devices may be used (e.g., other gas filled struts, alternatively combination coil-over spring and shock absorber assemblies may be used, etc.).

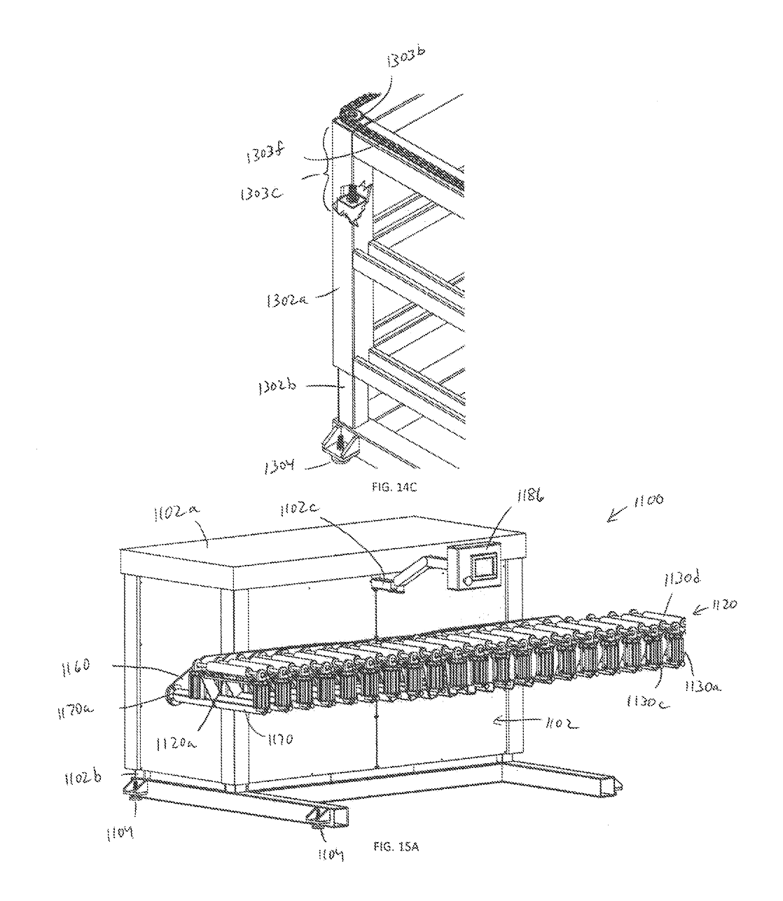

Another concept disclosed herein is an adjustable arm and bed arm assembly which allows for fine adjustment and alignment of the bed arm assembly with respect to the arm. In keeping with the above practices, items that are similar to previously discussed items will use the same latter two-digit reference numeral, but include the prefix “12” to distinguish one embodiment from others. Thus, in FIGS. 13A-B, the adjustable bed arm assembly 1261 is illustrated and connects pivoting or rotating arms 1260 to bed arms 1270. In the form illustrated, the arm 1260b of rotating arm assembly 1260 defines threaded bores 1261a, such as tapped bores or sleeves, and a fastener, such as bolt 1261b passes through an opening defined by the bed arm bracket 1270a, a nut 1261c and is thread into the threaded bores 1261a of the arm 1260b. The location of nut 1261c between the bed arm bracket 1270a and the arm 1260b allows the position of the bed arm assembly 1270 to be adjusted with respect to the rotating arm assembly 1260 to ensure proper alignment of the bed arm assembly 1270 and, specifically, the portion of the flexible bed 1220 associated therewith. In the form illustrated, the adjustable bed arm assembly 1261 includes three threaded bores 1261a, mating bolts 1261b and intermediate nuts 1261c as this provides sufficient ability to adjust the bed arm 1270 in any desired manner. However, it should be understood that in alternate embodiments fewer or more bores 1261a, mating bolts 1261b and nuts 1261c could be used. For example, in one form a single threaded bolt, intermediate nut and mating bore could be used. Such a configuration would likely only allow for longitudinal movement of the bed arm 1270 in/toward or out/away from the arm assembly 1260, however, this may be all that is needed for some embodiments of the invention. Similarly, in other embodiments more than three bores, bolts and nuts may be used. For example, if more fine adjustment is desired for the bed arm 1270, additional bores, bolts and nuts could be used. It should also be appreciated that although the depicted embodiment illustrates the arm as defining the threaded bore 1261a, the alignment of the components could easily be reversed so that the bed arm bracket 1270a defines the threaded bore 1261a, the arm defines an opening through which the bolt 1261b is passed and the nut is positioned between the arm assembly 1260 and bed arm bracket 1270a. Similarly, other structures capable of allowing finite adjustment of the bed arm 1270 with respect to the arm assembly 1260 may be used in alternate embodiments. For example, in one alternate form the bed arm 1270 may be connected to the arm assembly 1260 via a swivel-ball and nut design wherein the nut is loosened to allow finite positioning of the arm bed 1270 and then a nut is tightened down over the swivel-ball to prevent the swivel-ball and arm bed assembly 1270 from moving with respect to the arm 1260.

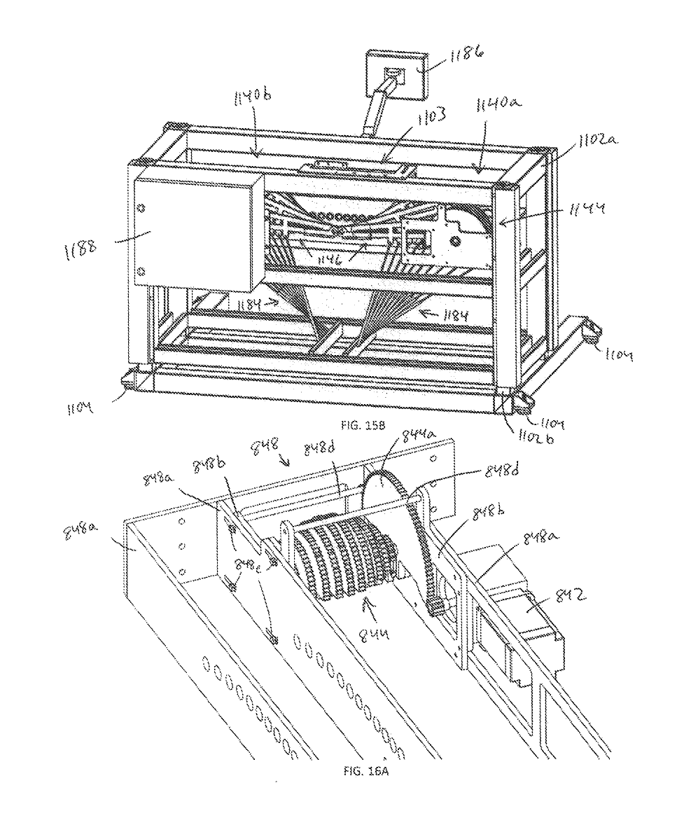

Yet another feature in accordance with the invention is illustrated in FIGS. 14A-C which may be used with any embodiment of the material forming apparatus. In keeping with the above, similar latter two-digit numerals will be used for items discussed above, but will have the prefix “13” to distinguish one embodiment from others. Thus, in FIGS. 14A-C an integrated lift mechanism is illustrated and referenced by reference numeral 1303. The integral lift mechanism 1303 is preferably incorporated into the upper housing portion 1302a and allows the material forming apparatus to be used with a variety of different sized workpieces by allowing the flexible bed to be raised and lowered to provide more and less clearance with a floor or other work surface, respectively. In one form, the lift mechanism 1303 includes chain driven sprockets that either drive an upper portion 1302a of the material forming apparatus upward with respect to the base 1302b of the apparatus or, alternatively, drive a lower portion (e.g., such as feet or posts) of the material forming apparatus downward to raise the flexible bed of the apparatus. In a preferred form, the lift mechanism 1303 allows an upper portion 1302a of the material forming apparatus 1300 to be raised with respect to the lower portion or base 1302b thereby elevating the height of the flexible bed from a first clearance with respect to the floor or work surface to a second clearance greater than the first so that larger workpieces can be formed and/or larger flexible beds used without causing the flexible bed and/or the workpieces from coming into contact with the floor surface upon which the apparatus is mounted, or other obstruction. In a preferred form,

In a preferred form, the lift mechanism includes a drive mechanism 1303a to move one of the upper portion 1302a and base portion 1302b with respect to the other of the upper portion 1302a and base portion 1302b to travel between the first and second clearances. The upper portion 1302a and base portion 1302b preferably have a telescoping engagement so that when the drive mechanism moves one of the upper portion 1302a and base portion 1303b with respect to the other, the upper portion 1302a and base portion 1302b telescope into one another to travel to the first clearance and out of one another to travel to the second clearance. The telescoping configuration helps minimize the foot print of the apparatus and allows the apparatus to take up less space when not in use.

In the form illustrated in FIGS. 14A-C, the lift mechanism 1303 comprises a plurality of chain driven sprockets 1303b connected to corresponding acme screw and fixed nut assemblies 1303c and the drive mechanism 1303a includes a motor 1303d and drive sprocket 1303e for driving a drive chain 1303f connected to the chain driven sprockets to rotate the chain driven sprockets in one direction of rotation to raise the upper portion 1302a of the housing with respect to the base 1302b to position the flexible bed at the second clearance, higher or greater than the first clearance, and in a second opposite direction of rotation to lower the upper portion 1302a of the housing with respect to the base 1302b to position the flexible bed at the first clearance or at least move it closer to the first clearance.

In the form illustrated, the lift mechanism 1303 further includes an integral tensioning mechanism 1303g for tensioning the drive chain 1303f driven by the motor 1303d and drive sprocket 1303e to reduce slippage between the drive chain 1303f and sprockets 1303b ad drive sprocket 1303e. As best illustrated in FIGS. 14A-B, the integral tensioning mechanism 1303g includes a spindle handle and threaded shaft that moves the entire motor 1303d and drive sprocket 1303e assembly away from the rear wall or frame of the apparatus 1300 and more toward the center of the cavity defined by the housing 1302. This causes the drive chain 1303f to tighten and remove slack in same to increase tension. If tension needs to be released the spindle handle and threaded shaft are rotated in an opposite direction of rotation to drive the motor 1303d and drive sprocket 1303e assembly toward the periphery of the housing 1302 and away from the center of the housing 1302 to add slack to the drive chain 1303f. Thus, with this configuration, the lift mechanism 1303 remains out of the way of the user or operator of the apparatus 1300 and the gear arrays, arm assemblies and bed arms, so as not to interfere with same.

In the embodiment illustrated in FIGS. 14A-C, the housing panels have been removed from the outer or upper housing portion 1302a to make the internal components of the housing more readily visible. In its finished form, the apparatus 1300 of FIGS. 14A-C would look more like the apparatus illustrated in FIG. 15A. In FIG. 15A, the apparatus 1100 is illustrated having an optional user interface, such as touch screen unit 1186, which is mounted to post member 1102c extending from the front of the apparatus 1100, which is connected to the upper housing portion 1102a and will raise and lower with the upper housing portion. In a preferred form, the user interface 1186 is connected to a controller, such a programmable logic controller or PLC, located in a rear access panel 1188 along with an electronic pressure regulator, air cylinder and second motor assembly for driving the second gear array 1140b located behind the access panel 1188. The first gear array would be driven by another motor (see motor 842 in FIG. 16A) and wired over to the controller in panel 1188.

In a preferred form, the apparatus 1100 is operated by first turning the main power switch on which is located in the rear enclosure 1188 located at the back of the apparatus 1100. Then the operator would press a home button on the touch screen 1186 to calibrate and level out the flexible bed 1120. The operator would then place the first cover member on the flexible bed 1120, followed by the desired workpiece to be formed, followed by the second cover member and then the roller clamps 1130d would be hooked into the bed arm assemblies 1170. The operator would press the air valve 1130c on each pneumatic cylinder to clamp down each roller on the workpiece and enter the clamping pressure and the radius desired on the touch screen. After pressing the start button located on the touch screen 1186, the apparatus will form the material as programmed via the touch screen 1186. The material will be left in the apparatus in the formed position and clamped long enough for it to hold its shape on its own, at which time the air valves can be opened to remove the roller clamps 1130d. The formed material can be removed and the bed can be put back into the home position for the next workpiece by hitting the home button on the touchscreen 1186.

In alternate embodiments, it should be appreciated that the touch screen 1186 and enclosure 1188 can be positioned elsewhere on the apparatus. It also should be understood that the apparatus 1100 may be provided with additional access panels, doors, drawers or windows. Further, the apparatus may include an illuminating device for illuminating at least a portion of the area in and/or around the apparatus housing. In a preferred form, a bank of LEDs is provided and mounted to the ceiling of the housing 1102 to illuminate the gear arrays 1140a, 1140b. A window may also be provided to allow the user to monitor operation of the apparatus if desired.

Methods and systems comprising the features specified in this disclosure are also contemplated in addition to a material forming machine or system. For example, methods of manufacturing a material forming machine are disclosed herein, methods of forming materials are disclosed herein, methods for bending workpieces are disclosed, methods for integrally lifting a material forming machine, methods for tensioning such integral lift mechanisms and gear engagement, as are methods for rotationally moving arms connected to a workpiece, methods for rotating arms off of a pivot point to create an arc, methods for continuously changing the pitch of a gear driven system to form a workpiece, methods for counterbalancing a gear driven system to free the system from excess strain, methods for keying and locking a gear system to prevent slippage and/or backlash, methods for calibrating and aligning moveable arms using adjustable drive gear assemblies, methods of engaging and disengaging drive and driven gears using a sled, methods of solidly engaging drive and driven gears, methods of spacing drive and/or driven gears, method of adjusting a bed arm with respect to a corresponding arm assembly, and methods of automating a material forming apparatus are all disclosed herein.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A material forming apparatus, comprising:
a housing defining an inner cavity and at least one opening through an outer surface of the housing;
an array of gears located within the inner cavity and driven by an actuator wherein the array of gears includes a plurality of drive gears and a plurality of driven gears with each driven gear associated with a corresponding drive gear to form a gear set and wherein at least one of the driven gear and/or corresponding drive gear are non-circular in order to have an ever changing pitch as the drive and driven gears engage and rotate with respect to one another;
a flexible bed having a plurality of bed arms with each bed arm being connected to a corresponding gear set via an arm shaft that extends through the at least one housing opening, the flexible bed arms being movable by the corresponding gear set between a first position where the plurality of flexible bed arms form a generally flat bed and a second position where each of the plurality of bed arms is positioned in a different position with respect to the other plurality of bed arms in order to manipulate the flexible bed into a curved shape; and
at least one clamp mechanism for clamping a workpiece to the flexible bed so that the workpiece is curved to match the curved shape of the flexible bed when the flexible bed is moved from the first position to the second position.

2. The material forming apparatus of claim 1 wherein the flexible bed comprises a first flexible cover member for covering a first side of the workpiece and the apparatus further comprising a second flexible cover member positioned on a second side of the workpiece with both the first and second flexible cover members capable of curving to match the curved shape of the flexible bed when the flexible bed is moved from the first position to the second position to protect and/or help curve the workpiece when the flexible bed is moved from the first position to the second position.

3. The material forming apparatus of claim 1 wherein the at least one clamp mechanism comprises a plurality of clamp mechanisms positioned to secure the workpiece at a plurality of different positions along the flexible bed.

4. The material forming apparatus of claim 3 wherein the plurality of clamp mechanisms comprise roller clamps positioned to secure the workpiece at a plurality of different positions along the flexible bed with each roller clamp having a roller that allows the clamp and/or workpiece to move with respect to one another as the flexible bed is moved between the first and second flexible bed positions.

5. The material forming apparatus of claim 4 wherein the roller clamps include at least one hand operated actuator for moving the roller of at least one roller clamp between a first released position wherein the roller is spaced apart from the workpiece and a second secured position wherein the roller is clamped to the workpiece such that the clamp allows the roller and/or workpiece to move with respect to one another as the flexible bed is moved between the first and second flexible bed positions.

6. The material forming apparatus of claim 5 wherein the at least one hand operated actuator comprises a plurality of hand operated actuators with each hand operated actuator being coupled to a respective roller clamp so that each hand operated actuator must be rotated in a first direction to move the roller to the first released position and rotated in a second direction opposite of the first to move the roller to the second secured position.

7. The material forming apparatus of claim 4 wherein the plurality of clamp mechanisms comprise pneumatic driven roller clamps positioned to secure the workpiece at a plurality of different positions along the flexible bed with each roller clamp having a roller that allows the clamp and/or workpiece to move with respect to one another as the flexible bed is moved between the first and second flexible bed positions, the apparatus further comprising a clamp actuator connected to the pneumatic roller clamps and being operable to move the rollers of each roller clamp between a first released position wherein the roller is spaced apart from the workpiece and a second secured position wherein the roller is clamped to the workpiece such that the clamp allows the roller and/or workpiece to move with respect to one another as the flexible bed is moved between the first and second flexible bed positions.

8. The material forming apparatus of claim 7 further comprising an air regulator and wherein the clamp actuator comprises at least one air valve that is actuated to move the roller between the first released position and the second secured position.

9. The material forming apparatus of claim 1 wherein the array of gears located within the inner cavity comprises a first array of gears corresponding to a first end of the flexible bed and having a second array of gears associated and a second end of the flexible bed.

10. The material forming apparatus of claim 9 having a first motor for driving the first array of gears and a second motor for driving the second array of gears and the apparatus comprising a controller for controlling operation of the first and second motors so that the flexible bed may be moved into the second position to form the workpiece and later returned to the first position for receiving another workpiece.

11. The material forming apparatus of claim 10 wherein the first array of gears is movable independent of the second array of gears to allow only one end of the workpiece to be worked on if desired.

12. The material forming apparatus of claim 1 wherein at least one of the drive gears and/or at least one of the driven gears is adjustable to align the gears and/or bed arm as desired.

13. The material forming apparatus of claim 1 wherein the drive gear is keyed to a drive shaft and includes an adjustable key insert that allows the drive gear to be adjusted as necessary for purposes of engaging and/or aligning the gears and/or bed arm as desired.

14. The material forming apparatus of claim 1 wherein the driven gear is keyed to the arm shaft and includes a gear lock assembly securing the drive gear against the keyed arm shaft to reduce the risk of slippage or backlash causing the apparatus to fall out of alignment or otherwise operate outside of desired parameters.

15. The material forming apparatus of claim 1 further comprising a counterbalancing system connected to the driven gears to reduce forces exerted on the gears and associated system components.

16. The material forming apparatus of claim 15 wherein the counterbalancing system comprises a plurality of shocks connected to a lower portion of the driven gear on one end and to a lower portion of the housing on an opposite end.

17. The material forming apparatus of claim 1 further comprising a plurality of spacers positioned between the drive gears to space the drive gears from one another.

18. The material forming apparatus of claim 17 wherein the plurality of spacers extend beyond an outer periphery of the drive gears and at least partly into gaps between the driven gears to align the drive gears and driven gears.

19. The material forming apparatus of claim 1 wherein the at least one opening defined by the housing comprises a plurality of openings through which at least a portion of the arm shafts are disposed, each arm shaft extending through one of the plurality of openings and having a corresponding friction reduction mechanism disposed between the arm shaft and the housing to reduce friction between the arm shaft and the corresponding housing opening so that the arm shaft can readily pivot as the drive gear of the corresponding gear set drives the driven gear.

20. The material forming apparatus of claim 1 wherein a first end of each arm shaft is connected to the driven gear of the corresponding gear set and a second opposite end of the arm shaft is connected to a corresponding arm and the bed arm associated with that arm so that pivotal movement of the arm shaft results in a corresponding pivotal movement of the arm and associated bed arm.

21. The material forming apparatus of claim 20 wherein the second opposite end of the arm shaft is tapered and keyed to the corresponding arm and permanently attached to the corresponding arm so that the arm shaft and arm are integrated with one another and pivotal movement of one results in a corresponding pivotal movement of the other.

22. The material forming apparatus of claim 1 wherein each bed arm is connected to the corresponding gear set via a corresponding arm shaft and corresponding arm and each bed arm is adjustably connected to the corresponding arm so that the position or alignment of the bed arm may be adjusted with respect to the corresponding arm to ensure proper positioning and alignment of same.

23. The material forming apparatus of claim 22 wherein the adjustable connection between the bed arm and corresponding arm comprises at least one fastener that allows the bed arm to be moved with respect to the corresponding arm and secured into position.

24. The material forming apparatus of claim 23 wherein the at least one fastener includes a bolt having a head with a threaded post extending therefrom and terminating in a distal end on a side opposite the head, the at least one fastener further includes a nut loco fed between the bolt head and the distal end of the bolt that is adjustable about a length of the threaded post in order to adjust the spacing between the bed arm and arm when the bolt is used to fasten the bed arm to the arm.

25. The material forming apparatus of claim 24 wherein the at least one fastener comprises a plurality of said bolts so that the nuts corresponding to each bolt may be used to position and/or align the bed arm with respect to the arm.

26. The material forming apparatus of claim 1 further comprising a lift mechanism connected to the apparatus for moving the flexible bed between a lowered position have a first clearance between the flexible bed and a work surface upon which the apparatus is rested and a raised position having a second clearance between the flexible bed and work surface upon which the apparatus is rested which is greater than the first clearance so that the apparatus may be used to form larger material without obstruction than would otherwise be allowable at the first clearance.

27. The material forming apparatus of claim 26 wherein the lift mechanism comprises an upper portion, a base portion and a drive mechanism to move one of the upper portion and base portion with respect to the other of the upper portion and base portion to travel between the first and second clearances.

28. The material forming apparatus of claim 27 wherein the upper portion and base portion have a telescoping engagement so that when the drive mechanism moves one of the upper portion and base portion with respect to the other of the upper portion and base portion telescope into one another to travel to the first clearance and out of one another to travel to the second clearance.

29. The material forming apparatus of claim 28 wherein the lift mechanism comprises a plurality of chain driven sprockets connected to corresponding acme screw and fixed nut assemblies and includes a motor and drive sprocket for driving a drive chain connected to the chain driven sprockets to rotate the chain driven sprockets in one direction of rotation to raise the upper portion of the housing to position the flexible bed at the second clearance and in a second opposite direction of rotation to lower the upper portion of the housing to position the flexible bed at the first clearance.

30. The material forming apparatus of claim 29 wherein the lift mechanism includes a tensioning mechanism for tensioning the drive chain driven by the motor and drive sprocket to reduce slippage between the drive chain and sprockets.

31. The material forming apparatus of claim further including an illuminating device for illuminating at least a portion of the area in and/or around the apparatus housing.

32. The material forming apparatus of claim 31 wherein the illuminating device is a light positioned within the housing for illuminating at least a portion of the interior cavity of the housing.

33. A material forming apparatus, comprising:
a housing defining an inner cavity and at least one opening through an outer surface of the housing;
an plurality of rotating arms with each arm having a bed member and clamp for clamping a portion of a workpiece, the plurality of rotating arms being moveable between a first position wherein the bed members are aligned for supporting a generally flat workpiece and a second position wherein each arm is moved to a unique position to form the workpiece into a desired radius of curvature; and
having at least one clamp mechanism for clamping the workpiece to one or more of the bed members so that the workpiece is formed into the desired radius of curvature when the rotating arms are moved from the first position to the second position.

34. A material forming apparatus according to claim 33 further comprising an integral lift mechanism that allows the height of a workpiece supporting bed to be raised from a first clearance with respect to an obstruction to a second clearance with respect to the obstruction greater than the first so that the material forming apparatus may form the material as desired without interference from the obstruction.

35. Adjustable drive gears comprising:
a plurality of drive gears driven by a common drive shaft, the drive gears being keyed to the drive shaft and adjustable with respect to the drive shaft so that fine adjustments may be made to one or more components coupled to the drive gears by adjusting the drive gears orientation with respect to the drive shaft.

36. A gear lock assembly for a driven gear keyed to an arm shaft, the gear lock assembly comprising:
a body keyed against at least one of the arm shaft and driven gear so that the body cannot move with respect to the at least one of the arm shaft and driven gear, and having a protrusion extending from the body and extending along a surface of the driven gear, the protrusion further defining a second opening; and
an adjustable lock member inserted through the second opening to further drive the body toward the at least one of the arm shaft and driven gear to prevent any slippage between the driven gear and the arm shaft.

37. A counterbalance system for a drive system comprising a plurality of drive gears coupled to a common drive shaft, and a plurality of driven gears each being driven by a corresponding drive gear from the plurality of drive gears and having rotatable arm shafts extending therefrom, the counterbalance system comprising a strut or shock connected to at least one of the drive gears, drive shaft and the driven gears on one end and a frame on another end and thereby reducing forces exerted on the drive system.

38. A gear spacing and alignment system comprising:
a plurality of drive gears coupled to a plurality of driven gears, the drive gears being coupled to a common drive shaft; and
a plurality of spacers spaced in between the drive gears and extending beyond a periphery of the driven gears and into a gap formed between the driven gears to space and align both the drive gears and driven gears and protect one or more of the gears from wear.
